(19) United States
(12) Patent Application Publication
(10) Pub. No.: US 2026/0357736 A1
(43) Pub. Date: Nov. 12, 2026

(54) ENGINE EXHAUST PURIFICATION DEVICE AND CATALYTIC CONVERTER FOR ENGINE

(71) Applicant: SUZUKI MOTOR CORPORATION, Hamamatsu-shi (JP)

(72) Inventors: Yuya ITO, Hamamatsu-shi (JP); Fumikazu KIMATA, Hamamatsu-shi (JP); Kazuya MIURA, Hamamatsu-shi (JP); Shota YOKOO, Hamamatsu-shi (JP); Kohei YAMAMOTO, Hamamatsu-shi (JP); Mai KUBOTA, Hamamatsu-shi (JP)

(73) Assignee: SUZUKI MOTOR CORPORATION, Hamamatsu-shi (JP)

(21) Appl. No.: 19/649,632

(22) Filed: Apr. 16, 2026

(30) Foreign Application Priority Data
May 12, 2025 (JP) 2025-079928

(51) Int. Cl. F01N 3/28; B01D 53/94; B01J 23/42; B01J 23/44; B01J 23/46; B01J 35/00

(52) U.S. Cl. CPC F01N 3/2803; B01D 53/945; B01J 23/42; B01J 23/44; B01J 23/464; B01J 35/19; B01D 2255/1021; B01D 2255/1023; B01D 2255/1025; B01D 2255/9032; B01D 2257/40; B01D 2257/502; B01D 2257/702; B01D 2258/01; F01N 2370/02; F01N 2510/0682; F01N 2510/0684; F01N 2590/021

(57) ABSTRACT

The exhaust purification device of the engine E includes an exhaust pipe 32 and exhaust purification catalysts 331 and 332. The exhaust purification catalysts include a first support 331s and a second support 332s disposed at an interval from the first support on a downstream side of the first support. On the inner surface of each of the first and second supports 331s and 332s, a catalyst coat 331b, 332b including a noble metal and a carrier component supporting the noble metal, and a dummy coat 331a, 332a including only the carrier component among the noble metal and the carrier component, are provided. In each of the first and second supports 331s and 332s, the dummy coat 331a, 332a is exposed to the internal flow path in a first region Ra1, Ra2 located on an upstream side, and the catalyst coat 331b, 332b is exposed in a second region Rb1, Rb2 located downstream of the first region.

### RELATED APPLICATIONS

This application claims the benefit of priority of Japanese Patent Application No. 2025-079928, filed on May 12, 2025, the entire contents of which are incorporated herein by reference.

### BACKGROUND OF THE INVENTION

### Field of the Invention

The present invention relates to an engine exhaust purification device and a catalytic converter for an engine.

### Description of the Related Art

During combustion in an engine, catalyst poisoning substances derived from engine oil, such as phosphorous compounds and sulfur oxide, are generated. By the catalyst poisoning substances, degradation of an exhaust purification catalyst progresses and exhaust purification performance by the exhaust purification catalyst deteriorates.

### SUMMARY OF THE INVENTION

Since an engine of an outboard motor has a high normal rotation number as compared to an engine of a two-wheeled vehicle or a four-wheeled vehicle and is often operated in a high load range, a consumption amount of engine oil tends to increase. Due to such a reason, there is a problem that an exhaust purification catalyst is greatly influenced by catalyst poisoning substances.

The catalyst poisoning substance tends to be deposited on an exhaust entrance side in particular, inside the exhaust purification catalyst. Deposition of the catalyst poisoning substance obstructs exhaust purification reaction in which a noble metal such as platinum and palladium is involved and action of oxygen occlusion and emission by a CZ material (ceria-zirconia composite oxide).

Examples of general measures include increasing a carrying amount of the noble metal and the CZ material inside the catalyst. By this measure, the exhaust purification performance can be enhanced, however, increase of the carrying amount is accompanied by a problem of cost increase.

In addition, since the above measure is not a fundamental solution to suppress influence itself of the catalyst poisoning substance, there is a concern that, during a high load operation (that is, during a high exhaust flow rate), a reaction speed cannot catch up even near a catalyst center portion where a sufficiently high temperature is expected and an unpurified exhaust harmful substance is discharged through a catalyst outer peripheral portion and its vicinity.

An object of the present invention is to provide an engine exhaust purification device and a catalytic converter for an engine capable of maintaining high exhaust purification performance over a long period of time.

In one aspect of the present invention, an engine exhaust purification device loaded on an outboard motor is provided. In this aspect, the engine purification device includes an exhaust pipe connected to an engine main body provided with a combustion chamber so as to convey exhaust after combustion in the combustion chamber, and an exhaust purification catalyst interposed in the exhaust pipe. The exhaust purification catalyst includes, as a support that forms an internal flow path through which the exhaust flows and holds a catalyst component, a first support, and a second support disposed at an interval from the first support on a downstream side of the first support with respect to flow of the exhaust. On an inner surface of each of the first and second supports, a catalyst coat and a dummy coat are provided. The catalyst coat contains a noble metal as the catalyst component and a carrier component carrying the noble metal, and a dummy coat contains only the carrier component out of the noble metal and the carrier component. The dummy coat is exposed in a first area on an upstream side and the catalyst coat is exposed in a second area on the downstream side of the first area, to the internal flow path, in each of the first and second supports.

In another aspect of the present invention, an engine exhaust purification device loaded on an outboard motor is provided. In this aspect, the engine exhaust purification device includes an exhaust pipe connected to an engine main body provided with a combustion chamber so as to convey exhaust after combustion in the combustion chamber, and an exhaust purification catalyst interposed in the exhaust pipe. The exhaust purification catalyst includes a support that forms an internal flow path through which the exhaust flows and holds a catalyst component, and the support includes a first exhaust purification coat and a second exhaust purification coat formed on an inner surface thereof, at an interval in a flow direction of the exhaust passing through the exhaust purification catalyst. Each of the first and second exhaust purification coats is provided with a catalyst coat containing a noble metal as the catalyst component and a carrier component carrying the noble metal, and a dummy coat containing only the carrier component out of the noble metal and the carrier component. The dummy coat is exposed to the internal flow path on an upstream side of the catalyst coat, in each of the first and second exhaust purification coats. A mixing promotion measure configured to promote mixing of the exhaust between the different internal flow paths is provided between the first exhaust purification coat and the second exhaust purification coat.

In a still further aspect of the present invention, a catalytic converter configured to be installed in an exhaust passage of an engine loaded on an outboard motor is provided. In this aspect, the catalytic converter includes a housing, and a support accommodated within the housing and forming an internal flow path through which exhaust of the engine flows. A catalyst coat and a dummy coat are formed on an inner surface of the support, the catalyst coat contains a noble metal serving as a catalyst component and a carrier component carrying the noble metal, and the dummy coat contains only the carrier component out of the noble metal and the carrier component. The dummy coat includes a first dummy coat, and a second dummy coat disposed at an interval from the first dummy coat on a downstream side of the first dummy coat with respect to flow of the exhaust passing through the catalytic converter, and each of the first and second dummy coats is exposed to the internal flow path. The catalyst coat is provided downstream of the second dummy coat with respect to the flow of the exhaust.

### BRIEF DESCRIPTION OF THE DRAWINGS

FIG. 1 is a schematic diagram illustrating an overall configuration of an engine according to one embodiment of the present invention;

FIG. 2 is a sectional view roughly illustrating a configuration of a catalytic converter;

FIG. 3 is a sectional view schematically illustrating an internal structure of the catalytic converter;

FIG. 4 is a schematic diagram schematically illustrating a deposition situation of a catalyst poisoning substance in an exhaust purification catalyst;

FIG. 5A is a schematic diagram illustrating a positional relationship in an example between a support, a dummy coat, and a catalyst coat;

FIG. 5B is a schematic diagram illustrating a positional relationship in another example between a support, a dummy coat, and a catalyst coat;

FIG. 5C is a schematic diagram illustrating a positional relationship in yet another example between a support, a dummy coat, and a catalyst coat;

FIG. 6 is a graph illustrating a phosphorous deposition amount Qp in a catalyst on each of an upstream side and a downstream side based on a relation with a distance Di from an entrance end face of each catalyst;

FIG. 7 is a graph illustrating an exhaust temperature inside the catalytic converter based on a relation with a distance D from an entrance end face of the exhaust purification catalyst.

FIG. 8 is a sectional view schematically illustrating a catalyst configuration in an exhaust purification catalyst according to another embodiment of the present invention; and

FIG. 9 is a sectional view schematically illustrating an internal structure of the catalytic converter according to yet another embodiment of the present invention.

### DETAILED DESCRIPTION OF THE INVENTION

Hereinafter, the embodiment of the present invention will be described with reference to the drawings.

### Overall Configuration of Engine

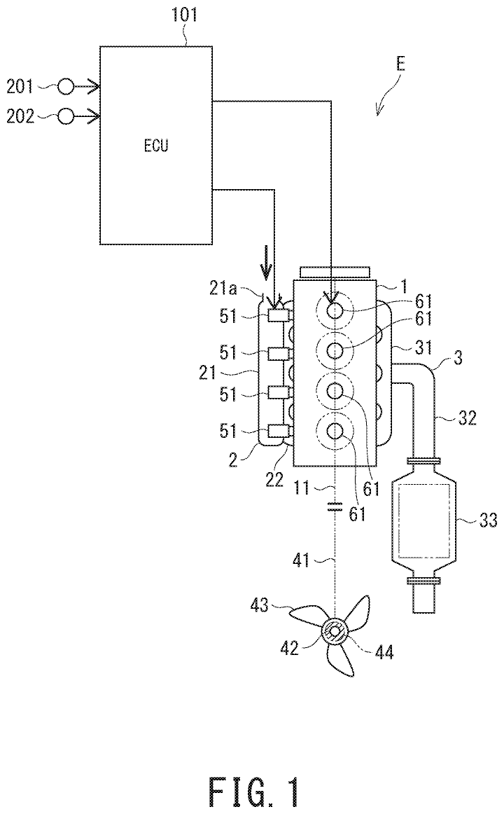

FIG. 1 is a schematic diagram illustrating an overall configuration of an internal combustion engine (simply referred to as an “engine”, hereinafter) E according to one embodiment of the present invention.

In description below, terms “upstream” and “downstream” are used in a relation with a flow direction of exhaust discharged from the engine E. For example, an upstream side of an exhaust purification catalyst is the upstream side of the exhaust purification catalyst in the flow direction of the exhaust, and a downstream side of the exhaust purification catalyst is the downstream side of the exhaust purification catalyst in the flow direction of the exhaust.

In the present embodiment, the engine E constitutes a drive source of an outboard motor, and the outboard motor is mounted on a hull rear portion by a transom bracket.

The engine E includes, in addition to an engine main body 1 provided with a combustion chamber, an intake system 2 and an exhaust system 3. The engine E according to the present embodiment is a 4-stroke engine with four cylinders disposed in series, however, a form of the engine E, that is, the number and arrangement of the cylinders in the engine E, and the number of strokes of the engine E further are not limited thereto. In addition to a 4-cylinder 4-stroke inline engine, various kinds of engines of a single cylinder, six cylinders, V arrangement, and two strokes or the like may be adopted.

The engine main body 1 includes a cylinder block, a cylinder head, and a crank case, a piston is inserted to the cylinder block, and a space formed between a crown surface of the piston and an inner surface of the cylinder head is the combustion chamber. In a state where the outboard motor is mounted on the hull rear portion, the engine E is disposed in such a direction that a cylinder bore center axis of the engine main body 1 is in a hull front-rear direction (referring to a direction perpendicular to a plane of FIG. 1, and referred to as a “front-rear direction” hereinafter) and the piston reciprocates in the front-rear direction. In other words, for the engine E, in the state where the outboard motor is mounted, a rotation center axis of a crank shaft 11 rises in an up-down direction.

Power that the engine E generates by combustion is transmitted to a drive shaft 41 via the crank shaft 11 connected to the piston and disposed in an upright state, is further transmitted to a propeller shaft 42 that extends in the front-rear direction, and rotates a propeller 43 mounted on a rear end portion of the propeller shaft 42. Between the drive shaft 41 and the propeller shaft 42, a power transmission mechanism 44 that converts rotation of the drive shaft 41 to rotation of the propeller shaft 42 and switches a rotation direction of the propeller shaft 42 between a forward rotation direction at the time of forward movement and a reverse rotation direction at the time of reverse movement is interposed. The power transmission mechanism 44 is provided with a pinion gear mounted on the drive shaft 41, and a reduction gear for the forward movement and the reverse movement that is mounted on the propeller shaft 42 and is to be selectively engaged with the pinion gear.

The intake system 2 includes a surge tank 21 and an intake manifold 22, and also includes an air cleaner (not illustrated) attached to an opening portion 21a of the surge tank 21. Air from which foreign matters such as dust are removed through the air cleaner is introduced into the surge tank 21. The intake manifold 22 is branched from the surge tank 21 and is connected to a side face portion of the cylinder head. The air that has flown into the surge tank 21 is distributed to each cylinder of the engine main body 1 through the intake manifold 22.

A fuel injector 51 is installed for each cylinder at the cylinder head, and fuel injected by the fuel injector 51 is mixed with the air that has passed through the intake manifold 22, and is introduced into the corresponding cylinder. Inside the cylinder, mixing of the fuel and the air proceeds and an air-fuel mixture is formed. Then, by executing ignition by an ignition plug 61 to the air-fuel mixture, the air-fuel mixture burns.

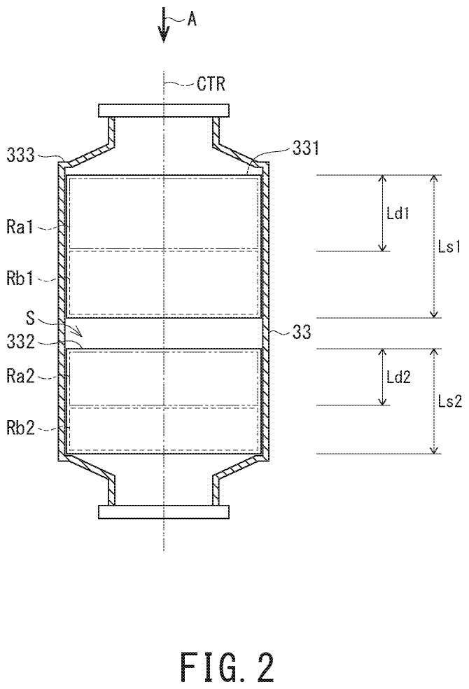

The exhaust system 3 includes an exhaust manifold 31 and an exhaust pipe 32, and also includes a catalytic converter 33. In the present embodiment, the exhaust pipe 32 extends in the up-down direction parallel to a cylinder arrangement direction, and the catalytic converter 33 is interposed in a vicinity of an exit or a lower end portion of the exhaust pipe 32 in a state where the center line CTR (FIG. 2) is upright. That is, exhaust passes through the catalytic converter 33 from an upper side to a lower side as illustrated by an arrow A.

After combustion, the exhaust remaining inside the cylinder is discharged to the exhaust manifold 31, and flows into the exhaust pipe 32 through a merging portion of the exhaust manifold 31. Then, the exhaust passes through the catalytic converter 33 downwards, and is discharged from the exhaust pipe 32 that continues on the downstream side of the catalytic converter 33 after harmful components (sometimes referred to as “exhaust harmful components” hereinafter) in the exhaust, such as total hydrocarbon and nitrogen oxide, are purified. Thereafter, the exhaust passes through the flow paths formed around the propeller shaft 42 and is discharged into the seawater.

The exhaust manifold 31, the exhaust pipe 32, and the catalytic converter 33 constitute an “exhaust purification device” according to the present embodiment. The catalytic converter 33 constitutes a “catalytic converter” according to the present embodiment.

### Configuration of Catalytic converter

FIG. 2 is a sectional view roughly illustrating the configuration of the catalytic converter 33.

The catalytic converter 33 is provided with exhaust purification catalysts 331 and 332 and a housing 333, and these two exhaust purification catalysts 331 and 332 are housed in the housing 333 in the state of being disposed in series in a direction (that is, an exhaust flow direction) A in which the exhaust passes through the catalytic converter 33.

Inside the housing 333, the catalyst (referred to as an “upstream side catalyst” hereinafter) 331 disposed on the upstream side and the catalyst (referred to as a “downstream side catalyst” hereinafter) 332 disposed on the downstream side are separated from each other in the exhaust flow direction A. That is, the upstream side catalyst 331 and the downstream side catalyst 332 are not in close contact with each other, and a space S with a determined length in the exhaust flow direction A is secured between the catalysts 331 and 332. The space S contributes to disturbing flow of the exhaust that has passed through the upstream side catalyst 331 before it flows into the downstream side catalyst 332 and to urging agitation of the exhaust.

The upstream side catalyst 331 and the downstream side catalyst 332 constitute the “exhaust purification catalyst” according to the present embodiment.

For each of the upstream side catalyst 331 and the downstream side catalyst 332, first areas Ra1 and Ra2 on the upstream side and second areas Rb1 and Rb2 that continue on the downstream side of the first areas Ra1 and Ra2 are defined. FIG. 2 schematically illustrates the first areas Ra1 and Ra2 as areas surrounded by frames of two-dot chain lines, and schematically illustrates the second areas Rb1 and Rb2 as areas surrounded by frames of broken lines. The first area Ra1 and the second area Rb1 are adjacent to each other or continue in the exhaust flow direction A in the upstream side catalyst 331, and the first area Ra2 and the second area Rb2 are adjacent to each other or continue in the exhaust flow direction A in the downstream side catalyst 332. In the present embodiment, in each of the upstream side catalyst 331 and the downstream side catalyst 332, the second areas Rb1 and Rb2 are continuous downstream of the first areas Ra1 and Ra2.

Since the upstream side catalyst 331 and the downstream side catalyst 332 are separated by the space S, the second area Rb1 of the upstream side catalyst 331 and the first area Ra2 of the downstream side catalyst 332 are in the state of being separated from each other in the exhaust flow direction A.

In the present embodiment, the first area Ra1 of the upstream side catalyst 331 is set longer in the exhaust flow direction A than the first area Ra2 of the downstream side catalyst 332. When a length of the first area Ra1 of the upstream side catalyst 331 is defined as Ld1 and a length of the first area Ra2 of the downstream side catalyst 332 is defined as Ld2, a relation indicated by an expression below is established between the lengths Ld1 and Ld2.

Ld1>Ld2 (1)

Furthermore, between the upstream side catalyst 331 and the downstream side catalyst 332, the second areas Rb1 and Rb2 have a similar tendency, and the second area Rb1 of the upstream side catalyst 331 is set longer in the exhaust flow direction A than the second area Rb2 of the downstream side catalyst 332. Thus, when a length of the entire upstream side catalyst 331 is defined as Ls1 and a length of the entire downstream side catalyst 332 is defined as Ls2, a relation indicated by an expression below is established between the lengths Ls1 and Ls2.

Ls1>Ls2 (2)

### Internal Structure of Catalytic Converter

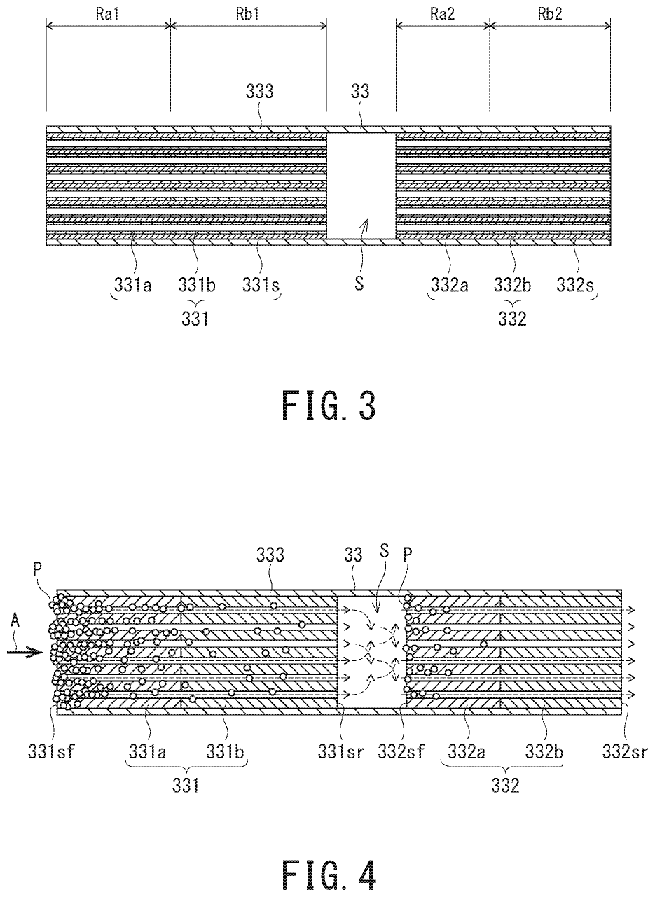

FIG. 3 is a sectional view schematically illustrating the internal structure of the catalytic converter 33.

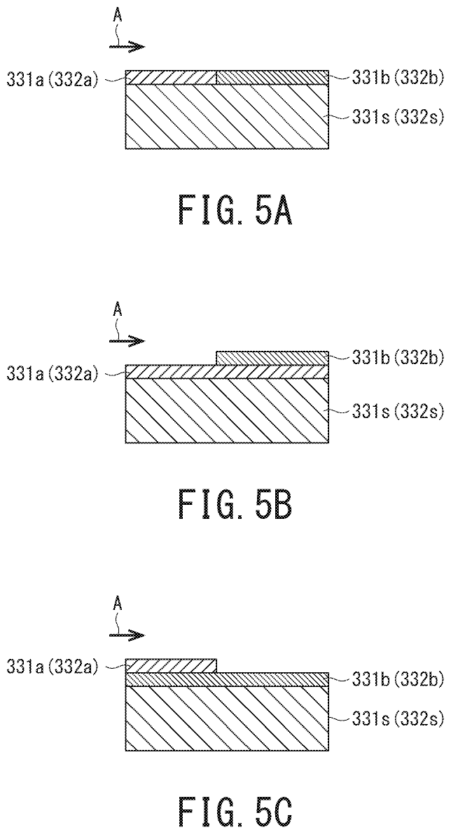

FIGS. 5A, 5B, and 5C are schematic diagrams schematically illustrating a positional relationship of a support, a dummy coat, and a catalyst coat.

With reference to FIG. 5A through 5C as appropriate, the internal structure of the catalytic converter 33 will be described based on FIG. 3.

The upstream side catalyst 331 and the downstream side catalyst 332 have roughly similar configurations. That is, the upstream side catalyst 331 and the downstream side catalyst 332 are provided with supports 331s and 332s, and are also provided with dummy coats 331a and 332a and catalyst coats 331b and 332b formed so as to cover inner surfaces of the respective supports 331s and 332s. A first support 331s constituting the upstream side catalyst 331 and a second support 332s constituting the downstream side catalyst 332 are accommodated within a common housing 333.

The first and second supports 331s and 332s both have a cylindrical honeycomb monolithic structure, and a plurality of internal flow paths through which the exhaust discharged from the engine main body 1 flows are formed. The exhaust flows into the upstream side catalyst 331 separately through the plurality of internal flow paths. Then, after passing through the upstream side catalyst 331, the exhaust is agitated in the space S, flows separately through the plurality of internal flow paths in the downstream side catalyst 332, and passes through it. For a cross sectional shape (that is, a cell shape) of the internal flow path, an appropriate shape such as a rectangular shape, a hexagonal shape, or a triangular shape (wave-like shape) can be adopted.

In the present embodiment, the internal flow paths formed respectively in the first support 331s and the second support 332s have identical shapes and areas in a cross section perpendicular to the exhaust flow direction. The first and second supports 331s and 332s have equal outer diameters or cross sectional areas, and the internal flow paths of the first support 331s and the second support 332s are arranged in series along the exhaust flow direction.

In the present embodiment, as the first and second supports 331s and 332s, metal supports are adopted. For a material of the supports, in addition to metal, an appropriate material such as ceramics can be adopted. For the material of the first and second supports 331s and 332s, the same material may be adopted or different materials may be adopted.

In the upstream side catalyst 331, the dummy coat 331a and the catalyst coat 331b are formed on the inner surface of the first support 331s, and in the downstream side catalyst 332, the dummy coat 332a and the catalyst coat 332b are formed on the inner surface of the second support 332s.

The catalyst coats 331b and 332b are coatings containing a noble metal as a catalyst component and a carrier component carrying the noble metal. In other words, they are the coatings for which the carrier component is fixed in the state of carrying the noble metal on the inner surfaces of the respective supports 331s and 332s. For the noble metal, at least one of platinum, palladium, and rhodium can be adopted. By attaining a so-called ternary configuration adopting the noble metal such as the platinum, the palladium, and the rhodium as the catalyst component, when the engine E is operated at a theoretical air-fuel ratio, oxidation of the total hydrocarbon and carbon monoxide as the exhaust harmful components and reduction of the nitrogen oxide as the exhaust harmful component are carried out in parallel, and high exhaust purification performance is demonstrated regarding these three kinds of the exhaust harmful components.

The dummy coats 331a and 332a are coatings not containing the noble metal and containing only the carrier component. For the carrier component of the dummy coats 331a and 332a, the carrier component in common with or the same as that of the catalyst coats 331b and 332b may be adopted or a different carrier component may be adopted. In the present embodiment, as the carrier component, inorganic oxide such as alumina is adopted. The dummy coats 331a and 332a may contain, in addition to the carrier component, one or more materials selected from basic materials such as cerium, lanthanum, or neodymium.

As the carrier component, ceria-zirconia composite oxide may be adopted instead of the alumina. As an example of adopting different carrier components for the dummy coats 331a and 332a and the catalyst coats 331b and 332b, the alumina is adopted for the dummy coats 331a and 332a and the ceria-zirconia composite oxide is adopted for the catalyst coats 331b and 332b.

As described above, in the present embodiment, in each of the upstream side catalyst 331 and the downstream side catalyst 332, the first areas Ra1 and Ra2 and the second areas Rb1 and Rb2 are formed continuously in the exhaust flow direction A so that the dummy coats 331a and 332a and the catalyst coats 331b and 332b are formed in the state where their end faces are in contact with each other.

Here, in each of the upstream side catalyst 331 and the downstream side catalyst 332, the dummy coats 331a and 332a are exposed to the internal flow paths in the first areas Ra1 and Ra2 on the upstream side, and the catalyst coats 331b and 332b are exposed to the internal flow paths in the second areas Rb1 and Rb2 on the downstream side. In the present embodiment, a range to form the dummy coats 331a and 332a and a range to form the catalyst coats 331b and 332b are segmented into the upstream side and the downstream side.

Specifically, as illustrated in FIG. 5(A), in each of the upstream side catalyst 331 and the downstream side catalyst 332, the dummy coats 331a and 332a are formed so as to cover the inner surfaces of the respective supports 331s and 332s only in the first areas Ra1 and Ra2, and the catalyst coats 331b and 332b are formed so as to cover the inner surfaces of the respective supports 331s and 332s only in the second areas Rb1 and Rb2.

Such a configuration can be realized by a following procedure, for example.

First slurry (containing only the carrier component) for forming the dummy coat and second slurry (containing both the catalyst component and the carrier component) for forming the catalyst coat are prepared. A target support is immersed in the first slurry over the range corresponding to the first areas Ra1 and Ra2 from the end face on one side, and the first slurry is applied onto the inner surfaces of the first areas Ra1 and Ra2. After drying the first slurry, the support is immersed in the second slurry over the range corresponding to the second areas Rb1 and Rb2 from the end face on the other side, and the second slurry is applied onto the inner surfaces of the second areas Rb1 and Rb2. After drying the second slurry, the first slurry and the second slurry are fired and fixed onto the inner surface of the support.

Concentrations of the noble metal in the catalyst coats 331b and 332b may be the same or may be different between the upstream side catalyst 331 and the downstream side catalyst 332. In the present embodiment, the concentrations of the noble metal in the catalyst coats 331b and 332b are made different between the upstream side catalyst 331 and the downstream side catalyst 332. Specifically, a concentration C1 in the catalyst coat 331b of the upstream side catalyst 331 is set higher than a concentration C2 in the catalyst coat 332b of the downstream side catalyst 332 (C1>C2).

The concentrations C1 and C2 of the noble metal are determined as a ratio of mass of the noble metal occupying the second slurry per unit mass. In the case of adopting the same carrier component in the upstream side catalyst 331 and the downstream side catalyst 332, a level of the concentrations C1 and C2 can be estimated by comparing weight of the catalyst coats 331b and 332b of the respective catalysts 331 and 332 with each other under same volume.

### Schematic Configuration of Control System

As illustrated in FIG. 1, the engine E includes an engine controller 101 and various kinds of sensors 201 to 202.

The engine controller 101 is configured as a microcomputer including a central processing unit (CPU), a storage device such as a ROM and a RAM, and an input/output interface, as an electronic control unit.

The engine E includes, as the sensors related to control of the operation state, an intake air amount sensor 201 and an engine rotational speed sensor 202. The intake air amount sensor 201 detects a flow rate Qa of air drawn into the cylinders of the engine E. An intake air amount Qa indicates a load requested to the engine E. The engine rotational speed sensor 202 detects a rotation number (referred to as an “engine rotation number” hereinafter) Ne of the engine E per unit time, as a rotational speed of the engine E.

The engine controller 101 controls the operation state of the engine E while controlling an air-fuel ratio of the air-fuel mixture used for the combustion based on the intake air amount Qa and the engine rotation number Ne. Specifically, as a command signal to the fuel injector 51, an injector drive signal for injecting the fuel for an amount equivalent to the intake air amount Qa is output.

### Function of Exhaust Purification Catalyst

FIG. 4 is a schematic diagram schematically illustrating a deposition situation of a catalyst poisoning substance in the exhaust purification catalysts 331 and 332.

When the engine E is operated, the exhaust discharged from the engine main body 1 contains, in addition to the exhaust harmful components such as the total hydrocarbon and the nitrogen oxide, the catalyst poisoning substance derived from engine oil, such as phosphorous compounds and sulfur oxide. Since the engine E used in the outboard motor has characteristics that a normal rotation number is high and it is often operated in a high load range, a consumption amount of the engine oil is large and a content of the catalyst poisoning substance in the exhaust tends to be large as well. The exhaust flows into the exhaust pipe 32 through the exhaust manifold 31 after being discharged from the engine main body 1, and flows into the catalytic converter 33 further.

The exhaust that has flown into the catalytic converter 33 passes through the upstream side catalyst 331, then flows into the downstream side catalyst 332 through the space S, and passes through the catalytic converter 33. FIG. 4 schematically illustrates the flow of the exhaust inside the catalytic converter 33 by broken lines. In each of the upstream side catalyst 331 and the downstream side catalyst 332, the exhaust passes through the first areas Ra1 and Ra2 where the dummy coats 331a and 332a are formed, and then flows into the second areas Rb1 and Rb2 where the catalyst coats 331b and 332b are formed.

In the upstream side catalyst 331, a catalyst poisoning substance P contained in the exhaust is intensively deposited near an end face 331sf on an entrance side of the first support 331s, in other words, near an entrance end face of the first area Ra1 where the dummy coat 331a is formed. This tendency is similar in the downstream side catalyst 332, and a large portion of the catalyst poisoning substance P contained in the exhaust that has passed through the upstream side catalyst 331 is deposited near an end face 332sf on an entrance side of the second support 332s in the downstream side catalyst 332.

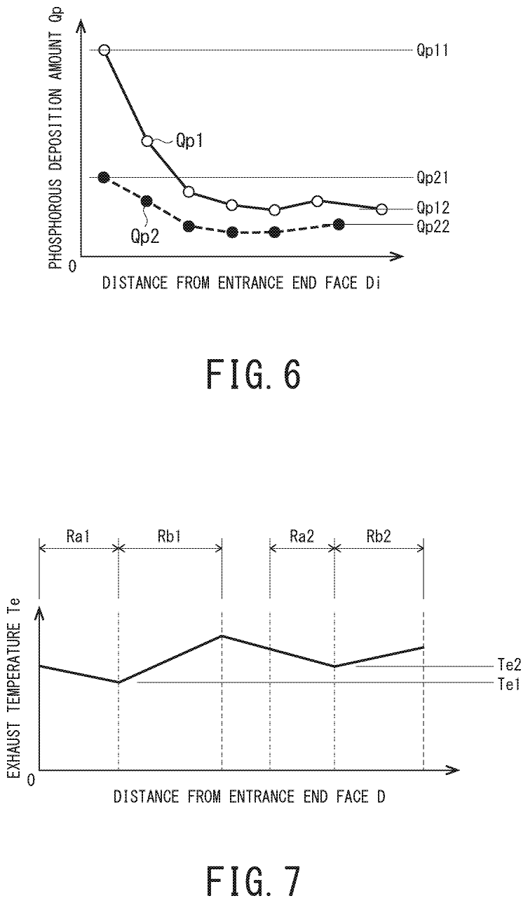

FIG. 6 is a graph illustrating a phosphorous deposition amount Qp in each of the upstream side catalyst 331 and the downstream side catalyst 332 based on a relation with a distance Di from the entrance end faces 331sf and 332sf of the respective supports 331s and 332s. A phosphorous deposition amount Qp1 in the upstream side catalyst 331 is indicated by white circles and a phosphorous deposition amount Qp2 in the downstream side catalyst 332 is indicated by black circles, respectively.

As illustrated in the figure, the phosphorous deposition amounts Qp1 and Qp2 are largest on or near the entrance end faces 331sf and 332sf in both of the upstream side catalyst 331 and the downstream side catalyst 332, and decrease as the distance Di from the entrance end faces 331sf and 332sf becomes longer away from the entrance end faces 331sf and 332sf.

Here, when the phosphorous deposition amount near the entrance end faces 331sf and 332sf and the phosphorous deposition amount near exit end faces 331sr and 332sr are compared between the upstream side catalyst 331 and the downstream side catalyst 332, the phosphorous deposition amount near the entrance end face is larger (Qp11>Qp21) and the phosphorous deposition amount near the exit end face is larger (Qp 12>Qp22) in the upstream side catalyst 331 than in the downstream side catalyst 332. Further, when a difference (referred to as a “phosphorous deposition change amount” hereinafter) between the phosphorous deposition amount near the entrance end face and the phosphorous deposition amount near the exit end face is compared, a phosphorous deposition change amount ΔQp1 (=Qp11−Qp12) in the upstream side catalyst 331 is larger than a phosphorous deposition change amount ΔQp2 (=Qp21−Qp22) in the downstream side catalyst 332 (ΔQp1>ΔQp2).

However, when the phosphorous deposition amount (referred to as an “upstream side exit deposition amount” hereinafter) Qp12 near the exit end face 331sr of the upstream side catalyst 331 and the phosphorous deposition amount (referred to as a “downstream side entrance deposition amount” hereinafter) Qp21 near the entrance end face 332sf of the downstream side catalyst 332 are compared, the downstream side entrance deposition amount Qp21 tends to be larger than the upstream side exit deposition amount Qp12. This tendency becomes even more noticeable in the engine E used as the power source for an outboard motor. It is indicated by an expression below.

Qp21>Qp12 (3)

Here, a significance of providing the dummy coat 332a not only in the upstream side catalyst 331 but also in the downstream side catalyst 332 is found. It is because that, if a substantial amount of the catalyst poisoning substance remains even in the exhaust that has passed through the upstream side catalyst 331 and the dummy coat 332a is not provided in the downstream side catalyst 332, the remaining poisoning substance is deposited on the catalyst coat 332b of the downstream side catalyst 332 and obstructs exhaust purification reaction in the downstream side catalyst 332.

### Description of Action and Effect

Hereinafter, the effect obtained by the present embodiment will be described.

First, in the exhaust purification device including the exhaust manifold 31, the exhaust pipe 32, and the catalytic converter 33, the first support 331s and the second support 332s are disposed one behind the other in the exhaust flow direction A as the supports that support the catalyst component, and the catalyst coats 331b and 332b containing the carrier component carrying the noble metal as the catalyst component and the dummy coats 331a and 332a containing only the carrier component out of the noble metal and the carrier component are formed on the inner surface of each of the first and second supports 331s and 332s. Then, in each of the first and second supports 331s and 332s, the dummy coats 331a and 332a are exposed on the upstream side and the catalyst coats 331b and 332b are exposed on the downstream side, to the internal flow paths through which the exhaust flows.

Thus, it is possible to capture the catalyst poisoning substance contained in the exhaust by the dummy coats 331a and 332a on the upstream side in each of the upstream side catalyst 331 provided with the first support 331s and the downstream side catalyst 332 provided with the second support 332s, and to suppress a situation where the catalyst poisoning substance is deposited on the catalyst coats 331b and 332b on the downstream side and the exhaust purification reaction in which the noble metal is involved is obstructed.

Here, by providing the plurality of supports as the support, specifically the first and second supports 331s and 332s, and disposing the pair of supports 331s and 332s at an interval in the exhaust flow direction A, the exhaust that has passed through the upstream side catalyst 331 is agitated when flowing into the downstream side catalyst 332 and is distributed on an entire transverse section of the downstream side catalyst 332, and the catalyst poisoning substance can be excellently captured by the dummy coat 332a of the downstream side catalyst 332.

Thus, in the engine E of the outboard motor with a relatively large consumption amount of the engine oil, it is possible to suppress poisoning of the catalyst coat 332b of the downstream side catalyst 332 and to maintain the exhaust purification performance in the entire exhaust purification catalysts 331 and 332 over a long period of time.

Second, by making the concentrations C1 and C2 of the noble metal in the catalyst coats 331b and 332b be different between the upstream side catalyst 331 and the downstream side catalyst 332, it is possible to reduce amount of the noble metal used through optimization of the concentrations in the catalysts 331 and 332 respectively on the upstream side and on the downstream side, and to improve the exhaust purification performance in the entire exhaust purification catalysts 331 and 332.

Third, by setting the concentration C1 of the noble metal in the catalyst coat 331b of the upstream side catalyst 331 higher than the concentration C2 of the noble metal in the catalyst coat 332b of the downstream side catalyst 332 (C1>C2), it is possible to increase a carrying amount of the noble metal in the catalyst coat 331b of the upstream side catalyst 331, to bring more noble metal into contact with the exhaust at a position close to the engine main body 1 (combustion chamber), to promote activity of the noble metal, and to improve exhaust purification efficiency by the catalyst coat 331b.

Further, it is possible to suppress the situation where the exhaust purification reaction in the catalyst coat 331b of the upstream side catalyst 331 becomes excessively stagnant due to the deposition of the catalyst poisoning substance and the exhaust purification performance in the entire exhaust purification catalysts 331 and 332 becomes insufficient.

On the other hand, the carrying amount of the noble metal becomes relatively small in the catalyst coat 332b of the downstream side catalyst 332, however, since a temperature of the exhaust is raised by the exhaust purification reaction in the catalyst coat 331b of the upstream side catalyst 331, it is possible to obtain the sufficient exhaust purification efficiency even with the small amount of the noble metal, and to secure the exhaust purification performance in the entire exhaust purification catalysts 331 and 332.

FIG. 7 is a graph illustrating an exhaust temperature Te inside the catalytic converter 33 based on a relation with a distance D from the entrance end face 331sf of the upstream side catalyst 331.

The exhaust flows into the catalytic converter 33 and then passes through the upstream side catalyst 331 in the order of the first area Ra1 and the second area Rb1. In the first area Ra1, since the noble metal is not carried by the dummy coat 331a, the purification reaction of the exhaust harmful components does not proceed, and the exhaust temperature Te declines as the distance D becomes longer. When the exhaust enters the second area Rb1, the exhaust purification component is promoted by the noble metal, reaction heat of the exhaust purification reaction is generated, and thus the exhaust temperature Te rises.

Until the exhaust reaches the second area Rb2 of the downstream side catalyst 332 after passing through the upstream side catalyst 331, the exhaust temperature Te declines due to same reasons. Then, when the exhaust enters the second area Rb2, the purification reaction of the remaining exhaust harmful component occurs, and the exhaust temperature Te rises again.

Here, when exhaust temperatures (referred as “exit end temperatures” hereinafter) Te1 and Te2 at respective exit ends are compared between the first area Ra1 of the upstream side catalyst 331 and the first area Ra2 of the downstream side catalyst 332, the exit end temperature Te2 in the downstream side catalyst 332 tends to be higher than the exit end temperature Te1 in the upstream side catalyst 331 (Te1<Te2). This is because the exhaust purification reaction in the upstream side catalyst 331 is positively made to occur by setting the concentration C1 of the noble metal in the catalyst coat 331b of the upstream side catalyst 331 relatively high.

Thus, it is possible to maintain the exhaust at a relatively high temperature even in the second area Rb2 of the downstream side catalyst 332, to promote the activity of the noble metal, and to achieve the sufficient exhaust purification efficiency even with the small amount of the noble metal.

Fourth, by adopting the platinum, the palladium, or the rhodium as the noble metal of the catalyst coats 331b and 332b, it is possible to excellently purify exhaust harmful substances.

Fifth, by containing the cerium, the lanthanum, or the neodymium in addition to the carrier component in the dummy coats 331a and 332a, it is possible to accelerate capture of the catalyst poisoning substance by the dummy coats 331a and 332a and to reduce the catalyst poisoning substance deposited on the catalyst coats 331b and 332b. The basic materials such as the cerium, the lanthanum, and the neodymium are highly reactive to the phosphorous and are especially effective in removal of a phosphorous compound.

Sixth, by forming the dummy coat 331a of the upstream side catalyst 331 longer in the exhaust flow direction A than the dummy coat 332a of the downstream side catalyst 332, it is possible to capture more catalyst poisoning substances by the dummy coat 331a of the upstream side catalyst 331 and to suppress influence exerted by the catalyst poisoning substance to each of the catalyst coat 331b of the upstream side catalyst 331 and the catalyst coat 332b of the downstream side catalyst 332.

In the present embodiment, by forming the dummy coat 331a of the upstream side catalyst 331 to be relatively long in the exhaust flow direction A, the area of the dummy coat 331a exposed to the internal flow path, in other words, the area of the dummy coat 331a exposed to the exhaust, is made larger in the upstream side catalyst 331 than in the downstream side catalyst 332. This increase in exposed surface area is not limited to this approach. It can also be achieved by forming each internal flow path narrower in the upstream side catalyst 331 so as to increase the total inner-surface area of the upstream side catalyst 331.

Seventh, by forming the catalyst coats 331b and 332b and the dummy coats 331a and 332a continuously in the exhaust flow direction A, a distance to reach the catalyst coats 331b and 332b becomes long in each of the upstream side catalyst 331 and the downstream side catalyst 332 so that it is possible to suppress the situation where the temperature of the exhaust is lowered at a point of time of reaching the catalyst coats 331b and 332b and the activity of the catalyst coats 331b and 332b or the noble metal is damaged.

### Description of Modifications

In the above description, as illustrated in FIG. 5A, in each of the upstream side catalyst 331 and the downstream side catalyst 332, the range to form the dummy coats 331a and 332a and the range to form the catalyst coats 331b and 332b are segmented, the dummy coats 331a and 332a are formed only in the first areas Ra1 and Ra2, and the catalyst coats 331b and 332b are formed only in the second areas Rb1 and Rb2.

A catalyst configuration of the respective catalysts 331 and 332 is not limited thereto, the dummy coats 331a and 332a or the catalyst coats 331b and 332b may be formed over the entire first and second areas Ra (Ra1, Ra2) and Rb (Rb1, Rb2) of the respective catalysts 331 and 332 and the coat to be exposed may be formed in an overlapping manner only in a corresponding location or area. FIG. 5B and FIG. 5C illustrate examples of the catalyst configuration in this case.

FIG. 5B is an example in the case of forming the dummy coats 331a and 332a over the entire first and second areas Ra and Rb of the respective catalysts 331 and 332 and forming the coats to be exposed (that is, the catalyst coats 331b and 332b) on the dummy coats 331a and 332a in an overlapping manner only in the second areas Rb1 and Rb2, in each of the upstream side catalyst 331 and the downstream side catalyst 332.

FIG. 5C is another example in the case of forming the catalyst coats 331b and 332b over the entire first and second areas Ra and Rb of the respective catalysts 331 and 332 and forming the coats to be exposed (that is, the dummy coats 331a and 332a) on the catalyst coats 331b and 332b in an overlapping manner only in the first areas Ra1 and Ra2, in each of the upstream side catalyst 331 and the downstream side catalyst 332.

### Description of Other Embodiments

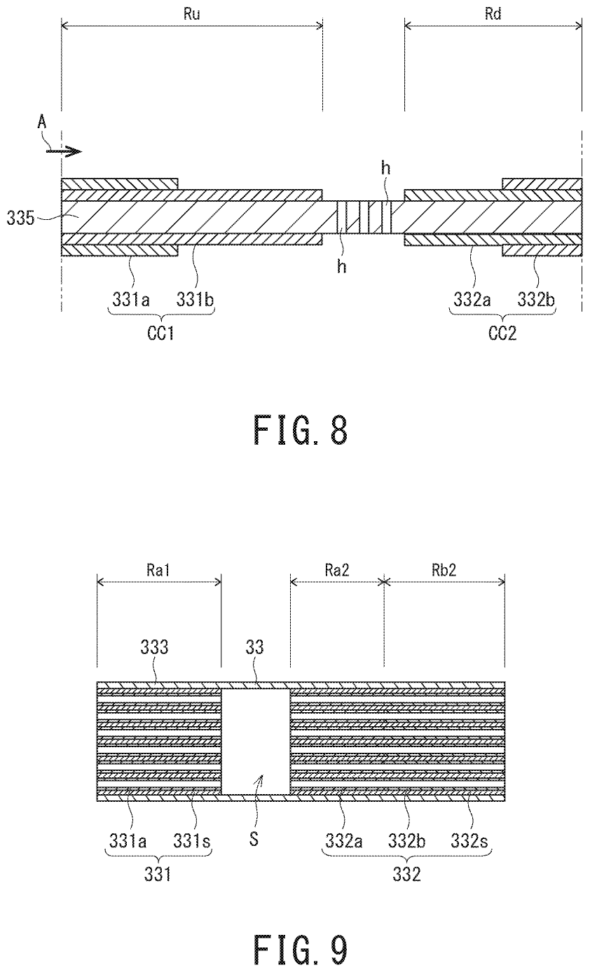

In the above description, the two supports (the first support 331s, the second support 332s) are adopted as the support that holds the catalyst component, and these supports 331s and 332s are disposed at an interval in the exhaust flow direction A. Without being limited thereto, one or a single support may be adopted and a coating (referred to as an “exhaust purification coat” hereinafter) formed of a dummy coat and a catalyst coat may be formed at an interval in the exhaust flow direction A on the inner surface of this one support. FIG. 8 illustrates, as an example of this case, the catalyst configuration in an exhaust purification catalyst according to another embodiment of the present invention.

As illustrated in FIG. 8, for one support 335, the exhaust purification coat CC1, CC2 formed of the catalyst coat 331b, 332b containing the carrier component carrying the noble metal served as the catalyst component and the dummy coat 331a, 332a not containing the noble metal and containing only the carrier component is formed in each of an upstream side area Ru that continues from the entrance end face and a downstream side area Rd set at an interval from the upstream side area Ru in the exhaust flow direction A.

Then, in each of the exhaust purification coat CC1 (corresponding to a “first exhaust purification coat”) provided in the upstream side area and the exhaust purification coat CC2 (corresponding to a “second exhaust purification coat”) provided in the downstream side area, the dummy coat 331a, 332a is exposed on the upstream side and the catalyst coat 331b, 332b is exposed on the downstream side, to the internal flow paths.

As a configuration alternative to the space S described above, between the two exhaust purification coats CC1 and CC2, a plurality of through-holes h are formed on an inner wall of the support 335, and the adjacent internal flow paths separated by the support 335 are communicated with each other through the plurality of through-holes 7. Since the exhaust flowing through the different internal flow paths is mixed with each other through the through-holes h, the agitation of the exhaust is promoted. Here, the through-holes h formed in the support 335 constitute a “mixing promotion measure” according to the present embodiment.

Furthermore, in the above description, a dummy coat 331a, 332a and a catalyst coat 331b, 332b are formed on the inner surface of each of the first support 331s disposed on the upstream side and the second support 332s disposed on the downstream side. However, not limited to this configuration, the dummy coats 331a and 332a may be formed on both the first and second supports 331s and 332s, while the catalyst coat 332b may be formed only on the second support 332s. FIG. 9 illustrates, as an example of this case, the internal structure of a catalytic converter 33 according to yet another embodiment of the present invention.

As shown in FIG. 9, within the housing 333 of the catalytic converter 33, two supports are arranged in the exhaust flow direction A: a first support 331s formed relatively short in the exhaust flow direction A, and a second support 332s formed longer than the first support 331s. The first support 331s is disposed near the inlet of the housing 333, and the second support 332s is disposed downstream of the first support 331s with a space S therebetween.

In the first support 331s, the dummy coat 331a is formed so as to cover the entire inner surface. In contrast, in the second support 332s, the dummy coat 332a is formed in the upstream first area Ra2, and the catalyst coat 332b is formed in the downstream second area Rb2 that follows the first area Ra2. Either of the methods shown in FIGS. 5A to 5C may be adopted to form the dummy coat 332a and the catalyst coat 332b on the second support 332s.

Accordingly, in the first support 331s, the dummy coat 331a is exposed to the internal flow paths over the entire length in the exhaust flow direction A. On the other hand, in the second support 332s, the dummy coat 332a is exposed in the upstream first area Ra2, and the catalyst coat 332b is exposed in the downstream second area Rb2.

As described earlier, it is also possible to employ one or a single support (see FIG. 8), in which only the dummy coat 331a is formed in an upstream area Ru, while both the dummy coat 332a and the catalyst coat 332b are formed in a downstream area Rd that is spaced apart from the upstream area Ru in the exhaust flow direction A. A through hole h penetrating the support in its thickness direction may be formed between these areas Ru and Rd, allowing the exhaust to mix between adjacent internal flow paths separated by the support via the through hole h.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An engine exhaust purification device loaded on an outboard motor, comprising:
an exhaust pipe connected to an engine main body provided with a combustion chamber so as to convey exhaust after combustion in the combustion chamber; and
an exhaust purification catalyst interposed in the exhaust pipe, wherein
the exhaust purification catalyst includes, as a support that forms an internal flow path through which the exhaust flows and holds a catalyst component, a first support, and a second support disposed at an interval from the first support on a downstream side of the first support with respect to flow of the exhaust,
provided on an inner surface of each of the first and second supports are
a catalyst coat containing a noble metal as the catalyst component and a carrier component carrying the noble metal, and
a dummy coat containing only the carrier component out of the noble metal and the carrier component, and
the dummy coat is exposed in a first area on an upstream side and the catalyst coat is exposed in a second area on the downstream side of the first area, to the internal flow path, in each of the first and second supports.

2. The engine exhaust purification device according to claim 1, wherein a concentration of the noble metal in the catalyst coat is different between the first support and the second support.

3. The engine exhaust purification device according to claim 2, wherein the concentration of the noble metal in the catalyst coat of the first support is higher than the concentration of the noble metal in the catalyst coat of the second support.

4. The engine exhaust purification device according to claim 1, wherein the catalyst coat contains, as the noble metal, at least one of platinum, palladium, or rhodium.

5. The engine exhaust purification device according to claim 1, wherein the dummy coat contains, in addition to the carrier component, at least one of cerium, lanthanum, or neodymium.

6. The engine exhaust purification device according to claim 1, wherein the dummy coat of the first support is formed to be longer in a flow direction of the exhaust than the dummy coat of the second support.

7. The engine exhaust purification device according to claim 1, wherein the catalyst coat and the dummy coat are formed continuously in a flow direction of the exhaust.

8. An engine exhaust purification device loaded on an outboard motor, comprising:
an exhaust pipe connected to an engine main body provided with a combustion chamber so as to convey exhaust after combustion in the combustion chamber; and
an exhaust purification catalyst interposed in the exhaust pipe, wherein
the exhaust purification catalyst includes a support that forms an internal flow path through which the exhaust flows and holds a catalyst component,
the support includes a first exhaust purification coat and a second exhaust purification coat formed on an inner surface thereof, at an interval in a flow direction of the exhaust passing through the exhaust purification catalyst,
each of the first and second exhaust purification coats is provided with
a catalyst coat containing a noble metal as the catalyst component and a carrier component carrying the noble metal, and
a dummy coat containing only the carrier component out of the noble metal and the carrier component,
the dummy coat is exposed to the internal flow path on an upstream side of the catalyst coat, in each of the first and second exhaust purification coats, and
a mixing promotion measure configured to promote mixing of the exhaust between the different internal flow paths is provided between the first exhaust purification coat and the second exhaust purification coat.

9. A catalytic converter configured to be installed in an exhaust passage of an engine loaded on an outboard motor, the catalytic converter comprising:
a housing; and
a support accommodated within the housing and forming an internal flow path through which exhaust of the engine flows, wherein
a catalyst coat and a dummy coat are formed on an inner surface of the support, the catalyst coat containing a noble metal serving as a catalyst component and a carrier component carrying the noble metal, and the dummy coat containing only the carrier component out of the noble metal and the carrier component,
the dummy coat includes
a first dummy coat, and
a second dummy coat disposed at an interval from the first dummy coat on a downstream side of the first dummy coat with respect to flow of the exhaust passing through the catalytic converter,
each of the first and second dummy coats is exposed to the internal flow path, and
the catalyst coat is provided downstream of the second dummy coat with respect to the flow of the exhaust.

10. The catalytic converter according to claim 9, wherein
the catalyst coat includes
a first catalyst coat provided between the first dummy coat and the second dummy coat, and
a second catalyst coat provided downstream of the second dummy coat with respect to the flow of the exhaust, and
the first catalyst coat and the second dummy coat are spaced apart from each other in a flow direction of the exhaust.

11. The catalytic converter according to claim 10, wherein
the first dummy coat and the first catalyst coat are formed continuously in the flow direction of the exhaust, and
the second dummy coat and the second catalyst coat are formed continuously in the flow direction of the exhaust.

12. The catalytic converter according to claim 10, wherein
the support includes
a first support on which the first dummy coat is provided, and
a second support on which the second dummy coat is provided, the second support being disposed at an interval from the first support on a downstream side of the first support with respect to the flow of the exhaust,
the first catalyst coat is provided on the first support downstream of the first dummy coat, and
the second catalyst coat is provided on the second support downstream of the second dummy coat.

13. The catalytic converter according to claim 12, wherein
the first dummy coat and the first catalyst coat are formed continuously in the flow direction of the exhaust on an inner surface of the first support, and
the second dummy coat and the second catalyst coat are formed continuously in the flow direction of the exhaust on an inner surface of the second support.

14. The catalytic converter according to claim 9, wherein the first dummy coat has a larger exposed surface area to the internal flow path than the second dummy coat.

15. The catalytic converter according to claim 10, wherein the first catalyst coat has a greater supported amount of the noble metal than the second catalyst coat.
